(19) United States
(12) Patent Application Publication
(10) Pub. No.: US 2005/0245418 A1
(43) Pub. Date: Nov. 3, 2005

(54) Detergent composition

(75) Inventors: Daniele Fregonese, Ludwigshafen (DE); Chris Efstathios Housmekerides, Ludwigshafen (DE); Ralf Wiedemann, Ludwigshafen (DE); Marcus Guzmann, Muehlhausen (DE); Roger Kaiser, Ludwigshafen (DE); Marcus Richter, Ludwigshafen (DE)

Correspondence Address: NORRIS, MCLAUGHLIN & MARCUS, 875 THIRD AVE, 18TH FLOOR, NEW YORK, NY, 10022, US

(73) Assignee: Reckitt Benckiser N.V., Hoofddorp (NL)

(21) Appl. No.: 10/519,119

(22) PCT Filed: Jun. 30, 2003
(86) PCT No.: PCT/GB03/02795

§ 371 Date: Dec. 23, 2004

(30) Foreign Application Priority Data
Jun. 28, 2002 (GB) 0214999.5
Aug. 24, 2002 (GB) 0219800.0

(51) Int. Cl. C11D 3/00

(52) U.S. Cl. 510/392

(57) ABSTRACT

The present invention comprises a detergent composition comprising an enzyme. The enzyme is at least partially encapsulated within water-soluble particles in a gel. The particles comprise a water-soluble encapsulating agent. The particles have a migration speed in the gel of less than one centimetre per month.

The present invention relates to a detergent composition, more particularly to a detergent composition comprising an enzyme partially disposed within particles in a gel, wherein the particles have a migration speed of less than 1 centimetre/month.

Enzymes find increasing use in detergents as a result of their ability to aid the removal of organic soils and stains from domestic articles. Enzymes are especially useful in the dispersion of food stains on clothing and cooking/eating utensils. Typical enzymes employed in this fashion include proteases to aid the removal of proteins and amylases, which act upon starch.

Unfortunately enzymes in detergent formulations, especially water-based formulations normally exhibit very poor stability. This problem is especially true at elevated temperatures and under the presence of UV light. Attempts to address this disadvantage in water based gel detergent formulations have included the application of known technologies such as increasing the ionic strength of a water based gel containing enzymes or by adding stabilising agents to the gel. However, a substantial deterioration of enzymes is still observed.

We have now found that the enzyme stability in such systems can be increased to a surprisingly high level when the enzymes are partially encapsulated and the so formed particles are then added to a gel in which the particles have limited mobility.

According to a first aspect of the present invention there is provided a detergent composition comprising an enzyme which is at least partially disposed within water-soluble particles in a gel, the particles comprising a water-soluble encapsulating agent, wherein the particles have a migration speed in the gel of less than one centimetre per month.

It has been found that as a result of the low motility of the particles, the particles once dispersed in the gel, remain dispersed therein, even after long periods of storage. Thus the problems of particle interaction and damage, as a result of particle congregation at or near an upper or lower portion of the gel are overcome.

Additionally as the particles remain evenly dispersed, even over prolonged periods of storage, the user can be sure when measuring/dispensing an amount of the detergent gel, that it contains the correct (rather than an excessive or insufficient) amount of particles (and associated enzyme). Furthermore the correct level of dispense may be achieved without the need to shake or otherwise agitate the gel which could otherwise cause detrimental particle deterioration.

Also, even though the enzyme is protected in storage in the particles, the particles are quickly disintegrated in use in a wash liquor (by virtue of the water-soluble encapsulating agent), thus allowing the enzyme to perform its function without delay.

Thus the current invention has been found to provide an enzyme containing detergent gel composition which displays surprisingly good enzyme stability during storage, whilst also ensuring a quick and efficient release of enzyme in use.

Preferably the migration speed of the particles is less than 0.7 cm per month and most preferably less than 0.4 cm per month.

Without wishing to be bound by theory the migration speed of the particles may be measured by the following preferred, yet non-limiting method.

The particles are dispersed in the gel and the gel is placed in a closed glass bottle (capacity 50 ml, width 3.5 cm). A picture is taken (Canon Powershot 30S camera, with the distance lens-bottle being 50 cm). The bottle is stored for 30 days at 25° C. A second picture is taken from the glass bottle and the locations of the particles are compared. Changes of location (Migration distance of particle on picture=Dₚ) are recorded in cm. The migration distance Dᵣ of an individual particle is determined according to the following formula, which overcomes any parallax error introduced by the picture taking process.
Dᵣ=Hᵣ×Dₚ/Hₚ
Hₚ=Bottle height on picture
Hᵣ=Real bottle height
Dₚ=Migration distance of particle on picture
Dᵣ=Real migration distance of particle

The result is taken from the average migration distance of 20 particles.

The preferred migration speed of the particles within the gel is preferably achieved by at least one of gel viscosity, gel density and particle density.

The gel preferably has a viscosity of greater than 4000 mPas, preferably greater than 6000 mPas, most preferably more than 10000 mPas. The viscosity was measured with a Brookfield RVT, spindle 27, 2.5 rpm at 25° C.

In order to achieve this viscosity the gel preferably contains a thickening agent. The thickening agent may be present in an amount of from 0.1% to 5% of the composition, more preferably between 0.5% to 2% and most preferably between 1% and 1.5% (e.g. such as 1.25%).

Preferred examples of thickening agents include polymeric substances which can function as viscosity enhancers and also add to cleaning performance characteristics. Exemplary of such polymeric compositions are polyacrylic acid, polymethacrylic acid, acrylic/methacrylic acid copolymers, hydrolyzed polyacrylamide, hydrolyzed polymethacrylamide, hydrolyzed polyacrylonitrile and hydrolyzed polymethacrylonitrile. These polymeric substances may be in the form of simple linear or branched polymers/co-polymers and/or may be cross-linked. Water soluble salts or partial salts of these polymers may be used. Most preferred polymeric substances are sold under the trademark Polygel DA (available from BASF), which is a polyacrylic acid having a molecular weight greater than 1,000,000, and also Carbopol 941 (available from B F Goodrich), also a polyacrylic acid having a molecular weight greater than 1,000,000.

Xanthan gum, either alone or in combination with a polymeric thickening agent may be employed as a thickener.

The gel preferably has a density of more than 1.1 g/cm³, more preferably more than 1.2 g/cm³ and most preferably more than 1.4 g/cm³.

The gel is preferably transparent. Transparent in this context means that particles which are covered by a gel layer of 1 cm are still visible under normal daylight conditions.

The gel is preferably substantially water free (having a water content of less than 5%).

Alternatively the gel may have a higher water content with a high ionic strength to prevent the particles from deteriorating in storage. Preferably the water content of the gel is from 5 to 65%, more preferably from 20 to 65% and most preferably from 35 to 65% (e.g. about 60%); the high ionic strength is preferably provided by a salt content which comprises at least 70%, more preferably at least 80% and most preferably at least 90% of the solid content (the non-aqueous component) of the gel.

Preferred examples of salts include phosphates, (such as tripolyphosphates) sulphates carboxylates and hydroxycarboxylates such as citrate, maleate, tartrate, isocitrate or tri-hydroxyglutarate. It is most preferred that the salt is a citrate salt. Generally the salts are alkali metal salts, especially sodium and potassium. When present in the amounts specified above these salts have been found to provide excellent builder performance.

The gel composition comprises an enzyme in an effective amount in the range of from about 0.05% to about 5%, preferably from about 0.5% to about 2%, by weight of the composition. Preferably the major part of the enzyme is present in the gel with a smaller part present in the particles. In this regard a suitable ratio of enzyme. present in the gel versus enzyme present in the particles would be between 5:1 and 20:1, with 8:1 to 15:1 being more preferred.

The enzymes suitable for use in the compositions include protease and amylase enzymes.

The protease enzymes suitable for the present compositions include the various commercial liquid enzyme preparations which have been adapted for use in association with detergent compositions. Enzyme preparations in powdered form are also useful although, as a general rule, less convenient for incorporation into liquid compositions. Suitable liquid enzyme preparations include “Alcalase”, “Savinase”, and “Esperase”, all trademarked products sold by Novo Industries, Copenhagen, Denmark, and “Maxatase”, “Maxacal”, and “AZ-Protease” and “Propease” sold by Gist-Brocades, Delft, The Netherlands.

Among the suitable amylase enzymes are those sold by Novo Industries and Gist-Brocades under the tradenames “Termamyl” and “Maxamyl”, respectively; also those sold by Genencor under the Tradenames ‘Purastar’.

Mixtures of different enzymes can and often are used to assist in removal of different types of stains. A portion of each enzyme may be disposed within the water-soluble particles.

In this regard a particular advantage of the present invention is that it allows formulation of a detergent gel composition containing two or more antagonistic enzymes. In this context antagonistic implies that one enzyme would upon contact ordinarily cause/be involved in the deterioration of one or more other enzymes present in the detergent gel, possibly together with itself.

This may be achieved by separate encapsulation of one or more of the enzymes within particles in the detergent gel. Namely, (explained with reference to a 2-enzyme containing system) two options are available. In the first option each enzyme may be encapsulated so that whilst the particles are intact interaction of the two enzymes is not possible. In the alternative, only one of the enzymes need be encapsulated to prevent contact.

In the case where a first enzyme is deteriorated by a second it is preferably to contain the first enzyme in the detergent gel and the second enzyme within the particles. In this arrangement the first susceptible enzyme has an opportunity in use after release to carry out its function, before the second enzyme is released from the water-soluble particle, i.e. before the second enzyme is able to detrimentally affect the first enzyme.

For example starch digesting enzymes such as amylase are usually deteriorated by protein digesting enzymes (proteases) on long-term storage. To address this problem, and using the present invention the amylase may be contained in the gel and the protease within the particles. This concept could of course also be applied in the reverse, wherein the protease is in the gel and amylase is in the particles.

Furthermore due to the nature of the gel an enzyme released prematurely from, for example, a leaking particle is kinetically hindered by the viscous nature of the gel. Thus destructive interaction with its antagonist is at least partially hindered.

The composition preferably comprises an amylase and/or a protease, to aid soil removal. Any of the encapsulation scenarios described in the paragraphs above is contemplated when both enzymes are present.

To further enhance the stability of the encapsulated enzyme a stabilising aid may be present, in the particles and/or in the gel.

Without wishing to be bound by theory it is proposed that the stabilising aid enhances the stability of the enzyme by “blocking” the active site thereof whilst the enzyme is encapsulated in the particle. As soon as the enzyme is dispersed in use (e.g. in a wash liquor) the stabilising aid is most preferably dispersed in the liquor. Thus the active site of the enzyme is free to act.

A stabilising aid is preferably present in the gel in an amount of from 0.05 to 20% (expressed as a percentage based upon the whole composition), more preferably 0.05 to 10%, more preferably 0.05 to 5% and most preferably 0.05 to 3%. A stabilising aid is preferably present in the particles in an amount of from 40 to 70% of the weight of the particles.

A preferred example of a stabilising aid for the gel is a water-miscible organic solvent. Such solvents include C₁₋₈ linear/branched alkanols; such as ethanol, isopropanol and butanol; and glycols such as ethylene glycol, propylene glycol and hexylene glycol. A particularly preferred solvent is propylene glycol. When the particularly preferred solvent (propylene glycol) is used it is preferably present in an amount of 0.05 to 2% by weight of the composition.

Further examples of stabilising aids for the gel include soluble calcium salts, such as calcium chloride. When a calcium salt is used it is preferably present in an amount of 0.05 to 5% by weight of the composition, more preferably 0.1 to 3%, more generally 0.2 to 2%, more preferably 0.4 to 1% most preferably about 0.5%.

Preferred examples of a stabilising aid for the particles include sugars and starches.

The particles are non-soluble in the gel during storage but disintegrate when the gel is exposed to the conditions of a laundry or dishwashing process. A typical dilution of the gel containing such particles in such process is 15-200 g, more preferred 20-150 g most preferred 25-50 g of gel in a wash water amount of 4-15 L, more preferred 4-8 L.

The particles comprise a water-soluble encapsulating agent. Water-soluble is herein defined when greater than 90% of 1 g of such material (in granular form having a particle size from 50-200 μm) dissolves after 40 min in a beaker containing 1 L of de-ionised water at 40° C. which is stirred with a stirrer revolving at 200 r.p.m.

The encapsulating agent may comprise a coating for the particles. Alternatively the encapsulating agent may comprise a portion of the core of the particle.

In the first case (where the encapsulating agent is a coating) the encapsulating agent may comprise 2-15% by weight, more preferably 2-10% by weight of the particle.

In the second case (where the encapsulating agent comprises a portion of the core of the particle) it is preferred that the encapsulating agent defines a matrix, within which any other components of the particle may be disposed. In this case the encapsulating agent may comprise at least 10% by weight and more preferably at least 20% by weight of the particle.

Most preferably the encapsulating agent comprises a coating.

Preferably the particles comprise a UV absorbing substance. Most preferably the UV absorbing substance is contained in the coating of this particle. A preferred example of a UV absorbing substance is Titanium Dioxide (TiO₂).

The encapsulating agent may contain a plasticiser. Preferred plasticisers include polyglycols and non-ionic surfactants.

Preferably the encapsulating agent is a cellulose derivative or a polyvinylalcohol derivative or a combination thereof.

The preferred density of the particles is expressed relative to that of the gel. The gel and the particles have a preferred difference in density no greater than 0.9 g/cm³, more preferably no greater than 0.6 g/cm³ and most preferably no greater than 0.3 g/cm³.

In order to achieve the desired density difference between the gel and the particles, the particles may incorporate a density aid. Preferred examples of density aids include titanium dioxide and calcium salts.

As pure enzymes typically have a dark brown colour, which is usually not appealing to a consumer, a pigment or a dye is generally included in the particles to make them more aesthetically appealing. Preferred examples of pigments include titanium dioxide and calcium salts (both of which provide a white coloration).

As can be seen it has been found that titanium dioxide and/or calcium salts can play a multiple number of roles in the particles (including stabilising agent, density aid and pigment).

The particles have a granule size distribution in which more than 80% of the particles are of the particle size from 50-1000 μm, more preferably from 200-800 μm and most preferably from 400-700 μm.

The particles preferably have a spherical shape. Most preferably the particles are dispersed evenly throughout the gel composition. When being dispersed, it will be appreciated that low shear methods are employed.

The particles may contain other detergent constituents, which are non-aggressive to the enzyme, such as a citrate or a phosphate (e.g. sodium or potassium tripolyphosphate) salt.

Preferably the particles comprise 0.1 to 5.0 weight %, more preferably 0.3 to 3.0 weight % and most preferably 0.5 to 2.0 weight % of the detergent composition.

The detergent composition is intended for use in dishwashing (both manual and automatic, most preferably automatic) and/or laundry applications.

The detergent composition may contain from about 0.05% to about 5% of a surfactant. Preferably the surfactant is non-ionic. A preferred example of a non-ionic surfactant is a block copolymer of a C₂-C₈ alcohol alkoxylated with an alkylene oxide. Without wishing to be bound by any scientific theory, it is believed that this ingredient acts both to improve the enzyme stability system and also to aid in stain removal. A wide variety of alkoxylated alcohols are known to the art and these vary considerably in HLB (hydrophile-lipophile balance). For purposes of this invention, it is preferable to employ an alkoxylated alcohol which is relatively hydrophobic, having a HLB in the range of 3 to 5. Preferred surfactants are propanol propoxylated with propylene oxide (block-wise) and then ethylene oxide (block-wise). Such a polymer is commercially available under the Tradename LF 500 (available from BASF).

To bring the pH to within the desired range of 7.0 to 8.5, a sufficient amount of alkali hydroxide, preferably sodium hydroxide, is added.

The detergent composition may also include the usual additives usually present in compositions of this type provided, of course, that they do not detract from enzyme stability. Such additives include perfumes, dyes, preservatives, antibacterial agents, fluorescent whitening agents, and pigments.

Suitable preservatives include isothiazolinones sold under the trademark Kathon (available from Rohm & Haas).

The product is preferably packed in a water-soluble packaging. Such packaging may be produced by thermoforming of a foil and then sealing of the formed and filled container; vertical form-fill-seal processes or injection moulding of compartments and subsequent filling and closing of such compartments.

We have also found that high enzyme stability in water-based detergent composition may be achieved by the use of a high content of ionic salt, even in the absence of recognised stabilization aids, such as borate. Thus in accordance with a second aspect of the present invention there is a provided an aqueous boron-free detergent composition comprising an enzyme, a stabilising amount of an organic water-miscible solvent wherein the composition comprises between 5 to 65% of water with at least 70% of the remainder of the composition comprising a water soluble ionic salt.

The features which refer to the first aspect of the invention shall apply mutatis mutandis to the second aspect of the invention.

By boron-free it is meant that no form of boron, such as a borate salt is present in the composition.

We have found that an efficient storage stable detergent composition which contains an active enzyme component may be produced without the need for the presence of boron, such as borates which have previously been used as stabilising means for enzymes in detergent formulations. This enables the detergent formulation to comply with increasingly common national and international regulations which set maximun limits for the use of boron containing compounds on environmental grounds.

Without wishing to be bound by theory it is proposed that the high enzyme stability arises from the high ionic strength of the composition. The organic solvent also acts as an aid in the enzyme stability.

A composition in accordance with the second aspect of the invention, is surprisingly storage-stable even at low pH, such as a pH of around 7. This is in contrast to a previously used high pH of around 10 to ensure acceptable stability. Additionally, the composition has been found to provide adequate in-wash performance at lower dosage than would be expected for a liquid composition.

We have also found that high enzyme stability in water-based detergent compositions may be achieved by the use of a composition having a high conductivity, even in the absence of recognised stabilisation aids, such as borate. Thus in accordance with a third aspect of the present invention there is provided an aqueous boron-free detergent composition comprising an enzyme, wherein the composition has a conductivity of greater than 80 micro-siemens.

We have surprisingly found that an enzyme may be stabilised in aqueous solution by ensuring that the conductivity of the solution is greater than 80 micro-siemens. This high enzyme stability has been observed in the absence of the conventional boron-based enzyme stabilisers.

The features which refer to the first aspect invention shall apply mutatis mutandis to the third aspect of the invention.

A composition in accordance with the third aspect of the invention may contain a thickener as specified above. Hereby, an additional advantage of providing a composition having a conductivity of more than 80 micro-siemens is that the performance of the thickener when incorporated in the composition is not detrimentally effected.

Without wishing to be bound by theory it is proposed that the performance of the thickener is not detrimentally effected because of the relatively low amount of ionic salt required to achieve the desired conductivity. It is recognised that thickeners typically achieve their objective by having a plurality of pendant groups (normally anionically charged) which swell and ‘trap’ water molecules. Ordinarily a high amount of ionic salt detrimentally effects the operation of these pendant groups. However, with a composition of the third aspect of the present invention, as the concentration of ionic salt is low the performance of the thickener is largely unaffected (this also applies to compositions in accordance with the second aspect of the invention). This has been found to be especially important for compositions containing ‘speckles’; it is most disadvantageous both from an aesthetic point of view and also a dosage point of view if the speckles are allowed to settle in storage. A composition with a satisfactory level of thickness aids the prevention of speckle settling.

Preferably the conductivity of the composition is greater than 90 micro-siemens, more preferably greater than 100 micro-siemens, more preferably greater than 120 microsiemens, more preferably greater than 150 microsiemens and most preferably greater than 200 micro-siemens.

To further enhance the enzyme stability a non-born containing enzyme stabiliser may be present. Preferably the stabiliser is a soluble calcium salt (as described with respect to the first aspect of the invention).

The invention is now illustrated with reference to the following non-limiting Examples.

### EXAMPLES

### Example 1

Protease (Properase supplied by Genecor) and amylase particles were made using a sugar core material mixed with the enzymes to produce prills. The prills were then coated with hydroxypropylmethylcellulose (alternatively polyvinylalcohol or mixtures of the two were used) which contained plasticiser (polyglycol or a nonionioc surfactant) and pigment dye (e.g. TiO₂). The resulting particles were comprised of sugar (40-70%), enzyme (2-20%) film forming water-soluble material (2-10%), plasticiser (1-5%), pigment (0-10%) and dye (0-0.2%). Standard prill making and coating technologies provided by e.g. equipment as produced by Glatt were used to make the particles. The particles produced had a particle size wherein 80% of the particles had a diameter in the range 200-600 μm.

A gel was made up having the following composition:

| Component | Wt % |
|---|---|
| Dehardened Water | 37.428 |
| Sulphuric acid (50%)* | 0.105 |
| Dye | 0.0025 |
| Polyacrylic acid (thickener) | 0.800 |
| Sodium citrate | 30.000 |
| Potassium tripolyphosphate | 30.000 |
| Properase particle | 1.080 |
| Amylase particle | 0.340 |
| Perfume | 0.300 |
| | 100.00 |

*Sulphuric acid is added to water to facilitate the dispersion of the thickener. After dispersion of thickener all other ingredients are added.

The resultant detergent composition was stored in sealed glass containers in the dark for twelve weeks at 20° C. or 35° C.

Table I shows the activity of the enzymes from the particles compared to enzyme activity of an enzyme solution stored under the same conditions.

TABLE I
Remaining Enzyme Activity After 12 Weeks

| Protease | Amylase |
|---|---|
| Enzyme Particle | Enzyme Particle |

| | | | |
|---|---|---|---|
| 20° C. | 100% | 20° C. | 100% |
| 35° C. | 89.10% | 35° C. | 96.40% |

| | |
|---|---|
| Enzyme Solution** | Enzyme Solution** |

| | | | |
|---|---|---|---|
| 20° C. | 99.40% | 20° C. | 73.40% |
| 35° C. | 77.20% | 35° C. | 67.50% |

**enzyme solution is available as Purastar ST 15000 L (amylase) and Properase 1600 L (protease) both ex Genencor.

The formulation according to Example 1 shows improved stability of the enzymes when present in a composition in accordance with the inventions.

### Example 2

The table shows a composition according to the invention.

| Component | Wt % |
|---|---|
| Dehardened water | 61.339 |
| Monopropylene glycol | 1.850 |
| Sulphuric acid (30%) | 0.100 |
| Preservative | 0.100 |
| Polyacrylic acid (thickener) | 1.250 |
| Trisodium citrate | 32.800 |
| Sodium hydroxide | 0.110 |
| Calcium chloride | 0.500 |
| Amylase particles (Purastar Oxam) | 0.500 |
| Nonionic surfactant | 0.200 |
| Perfume | 0.050 |
| Protease liquid (Savinase) | 0.650 |
| Amylase liquid (Purastar 1500 L) | 0.550 |
| Dye | 0.001 |
| | 100.000 |

The gel composition has a conductivity of 90 microsiemens.

The formulation according to example 2 shows good stability of the enzyme (amylase) which is contained in the particles.

The detergent composition was stored in sealed glass containers in the dark for twelve weeks at 20° C. or 35° C.

Table II shows the overall activity of the enzyme following storage.

For the amylase enzyme the activity of a comparative amylase enzyme solution is also shown in some instances (in parentheses).

TABLE II

| | |
|---|---|
| Amylase | Protease |

| | | | |
|---|---|---|---|
| 20° C. | 100% (73.4%) | 20° C. | 91% |
| 30° C. | 92% (67.5%) | 30° C. | 85% |
| 40° C. | 82% | 40° C. | 55% |

### Example 3

The detergent formulation in Example 2 (and also the same formulation without speckles) was tested in a dose of 4.5 g using a Bosch® dishwasher machine, type 5062, Universal cleaning programme 50° C., water hardness 9° dH, heavily soiled in accordance with the IKW method (IKW-Arbeitskreis Maschinenspülmittel, “Methoden zur Bestimmung der Reinigungsleistung von maschinellen Geschirrspülmitteln (Part A and B)”, SÖFW, 11+14, 1998) and loaded as specified by the IKW method. The test samples used were standardised to comply with the IKW method and soiled with green tea, lipstick, rice, protein and burnt stains. The stained samples were placed in the dishwasher and washed under the conditions described above.

Three commercial available powder formulations (designated A, B, C) were also tested. 5 g of these formulations was used.

Removal of the stains was then marked from visual observation in accordance with the IKW method on a scale of 0 (=unchanged very strong staining) to 10 (=no staining).

The results are set out in Table III below:

TABLE III

| | Composition | | | | |
|---|---|---|---|---|---|
| | Ex 2 | | | | |
| Stain | (without speckles) | Ex 2 | A | B | C |
| Green Tea | 7.2 | 7.4 | 5.5 | 7.4 | 7.9 |
| Lipstick | 4 | 3 | 4.4 | 5.3 | 4.7 |
| Rice | 5.14 | 7.3 | 4.4 | 7.2 | 7.4 |
| Protein | 1 | 1.6 | 1.2 | 1.1 | 1.7 |
| Burnt Stain | 5.8 | 5.8 | 3.1 | 3 | 6.5 |
| AVERAGE | 4.63 | 5.02 | 3.72 | 4.8 | 5.64 |

By comparing the columns of the table, it may be seen that the compositions in accordance with the invention produce very good results which are similar to or better than commercially available powder formulations.

This is surprising as usually a higher dosage of liquid detergent is needed to achieve similar results to those of a powder. Here not only are similar results achieved but also at 10% lower dosage than for powder formulations.

### Example 4

The detergent formulation in Example 2 was tested as in Example 3. The test samples used were standardised to comply with the IKW method and soiled with tea, starch, rice, protein and burnt stains.

Three other phosphate based liquid detergent compositions were tested (designated A′, B′ and C′). The composition of A′ and B′ is given below:

Wt %

| Component | A′ | B′ |
|---|---|---|
| Dehardened water | 60.800 | 37.380 |
| Potassium Tripolyphosphate | 5.500 | 32.000 |
| Sodium Tripolyphosphate | 9.500 | — |
| Sodium Silicate | 15.000 | — |
| Sodium Bicarbonate | 0.100 | — |
| Sodium Hypochlorite (12.5%) | 4.900 | — |
| Sulphuric acid (30%) | — | 0.100 |
| Polyacrylic acid (thickener) | 1.200 | 0.800 |
| Trisodium citrate | — | 30.000 |
| Potassium hydroxide (45%) | 3.000 | — |
| Perfume | — | 0.300 |
| Protease liquid | — | 1.080 |
| Amylase liquid | — | 0.340 |
| Dye | 0.080 | 0.025 |
| | 100.00 | 100.000 |

Formulation C′ is a commercially available phosphate based dishwasher detergent formulation.

Removal of the stains was then marked from visual observation in accordance with the IKW method.

The results are set out in Table IV below:

TABLE IV

Composition

| Stain | Ex 2 | A′ | B′ | C′ |
|---|---|---|---|---|
| Tea | 4.2 | 10 | 3.2 | 4.1 |
| Starch | 9.8 | 6.2 | 9.4 | 7.3 |
| Protein | 7.6 | 2.3 | 8.3 | 8.9 |
| Burnt Stain | 8.1 | 8 | 7.8 | 9.8 |
| AVERAGE | 7.43 | 6.63 | 7.18 | 7.53 |

By comparing the columns of the table, it may be seen that a composition in accordance with the invention produce very good results which are similar to or better than commercially available phosphate containing liquid formulations.

1. An aqueous boron-free detergent composition comprising an enzyme, a stabilising amount of an organic water-miscible solvent, wherein the composition comprises between 5 to 60% of water with at least 70% of the remainder of the composition comprising a water soluble ionic salt.

2. A composition according to claim 1, wherein the enzyme is at least partially encapsulated within water-soluble particles in a gel, the particles comprising a water-soluble encapsulating agent, wherein the particles have a migration speed in the gel of less than one centimetre per month.

3. A composition according to claim 1, wherein the migration speed of the particles is less than 0.7 cm per month.

4. A composition according to claim 2, wherein the migration speed of the particles is less than 0.4 cm per month.

5. A composition according to claim 1, wherein the composition has a viscosity greater than 4,000 mPas.

6. A composition according to claim 1, wherein the gel contains a thickening agent.

7. A composition according to claim 6, wherein the thickening agent is polyacrylic acid.

8. A composition according to claim 1, wherein the composition has a density of greater than 1.1 g/cm³.

9. A composition according to claim 1, wherein the non-aqueous portion of the composition has a salt content of at least 80%.

10. A composition according to claim 9, wherein the salt is a phosphate, sulphate, carboxylate or hydroxycarboxylate.

11. A composition according to claim 10, wherein the salt is a citrate salt.

12. A composition according to claim 1, comprising from 0.05 to 5% enzyme.

13. A composition according to claim 1, wherein the composition comprises a plurality of enzymes.

14. A composition according to claim 2, wherein the particles contain an enzyme such that the ratio of gel enzyme to particle enzyme is between 5:1 and 20:1.

15. A composition according to claim 1, wherein the enzyme is a protease and/or an amylase.

16. A composition according to claim 1, wherein an enzyme stabilising aid is present in the gel in an amount of from 0.05 to 20% (expressed as a percentage based upon the whole composition).

17. A composition according to claim 16, wherein the stabilising aid is a water-miscible organic solvent.

18. A composition according to claim 17, wherein the water-miscible organic solvent is propylene glycol.

19. A composition according to claim 18, wherein the stabilising aid is a soluble calcium salt.

20. A composition according to claim 1, wherein the particles comprise a stabilising aid in an amount of from 40 to 70% of the weight of the particles.

21. A composition according to in claim 20, wherein the stabilising aid is a sugar or a starch.

22. A composition according to claim 2, wherein the gel and the particles have a difference in density of no greater than 0.9 g/cm³.

23. A composition according to claim 22, wherein the particles contain a density aid.

24. A composition according to claim 2, wherein the particles contain a dye or a pigment.

25. A composition according to claim 1, wherein more than 80% of the particles have a particle size from 50 to 1,000 micrometres.

26. A composition according to claim 1 for use in dishwashing or laundry applications.

27. A method of dishwashing or laundry comprising the use of a detergent composition in accordance with claim 1.
